(19) United States
(12) Patent Application Publication
(10) Pub. No.: US 2010/0085900 A1
(43) Pub. Date: Apr. 8, 2010

(54) SYSTEM AND METHOD FOR MANAGING COMMUNICATION BETWEEN PARTIES

(76) Inventors: Petri Stenman, Helsinki (FI); Petri Pellinen, Espoo (FI); Timo Ahokas, Helsinki (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/521,297

(22) PCT Filed: Dec. 12, 2007
(86) PCT No.: PCT/FI2007/000289

§ 371 Date: Sep. 18, 2009

(30) Foreign Application Priority Data
Dec. 28, 2006 (FI) 20061162

(51) Int. Cl. H04L 12/16; H04L 12/66

(52) U.S. Cl. 370/259; 370/352

(57) ABSTRACT

Communication between a client and server software is managed in an environment that has at least one mobile station that has the client software installed therein, and a contact center for incoming and outgoing calls. The client software and the server software have functionalities for handling information in connection with incoming and outgoing calls. These functionalities has means for enabling components in the environment to record and connect data to incoming and outgoing calls in order to form a basis according to which calls are handled.

### TECHNICAL FIELD

The invention is concerned with a system and method for managing communication between parties, especially between client and server software in an environment comprising at least one mobile station having said client software installed therein, and a contact center for incoming and outgoing calls.

### BACKGROUND

Enterprises utilize contact center software systems to manage communication between employees and customers of the enterprise. The contact center software systems are traditionally tightly integrated with fixed line telephony systems. Today, a significant portion of the employees can only be reached on their mobile phone when they are away from their desk, which can take place a major portion of their time.

Problems arise when using the above systems in companies with large contact centers, e.g. in banks. Such companies often receive calls that require expert knowledge and worker participation. Those workers are, however, usually not located in the contact center as they are mobile to some extent.

When someone calls to an employee (a non contact center user), the contact center does not know if an employee can take calls or indeed be reached at all. In a typical situation, an employee to be reached by a customer first receives a call from the contact center. If the employee answers the call, he is then asked to take a call from the customer. It is a problem from the employee's viewpoint that he has to decide whether to answer the call without any additional information about the severity of the situation. As a result, calls from the contact center might be routinely ignored during e.g. meetings.

When a customer calls, the contact center can put the customer on hold and make an interim call to the mobile worker. The contact center then forwards the call to the mobile worker if the mobile worker can be reached and agrees to take the call. The contact center can also leave a message (e.g. a voice mail, a Short message Service (SMS) message, e-mail or the like) to the worker and the customer can be told that the worker will call back.

VoIP vendors (Voice Over Internet Protocol) have solutions where presence is tied with a worker's SIP client on the phone. SIP (Session Initiation Protocol) is a signaling protocol for typical mobile applications such as Internet conferencing, telephony, presence, events notification, and instant messaging. It connects the mobile device or any kind of client with the server. SIP ensures an integrated IP environment for mobile devices. As a protocol, it is standardized by the IETF (Internet Engineering Task Force), while 3GPP is standardizing the way SIP is used in mobile networks. In mobile networks, SIP find-and-connect functionality is provided by IP Multimedia Subsystem (IMS). IMS has been defined in 3GPP Release 5 standard, providing the mobile operators a common and well standardised platform for deploying SIP applications. Typically these solutions only work with the vendor's own contact center software but not with other software.

WO publication 2006/037836 is presented as an example of such prior art. This invention relates to a method and means for controlling the ability of mobile agents to receive customer calls to their mobile phone from a call center. The solution involves a mobile station installed with a client application featuring an agent profile and call processing rules that are updated from the call center. The mobile user uses the mobile station by turning on a work profile, and the client application registers the mobile user to the call center. With the work profile on, the client application can block personal calls or any other calls originating elsewhere than the call center or it can have a set of rules in accordance with which the incoming and outgoing calls are processed. The client application and/or the call center can also maintain a call queue with calls of different priority according to which the calls are forwarded.

The object of the invention is an improved customer and worker management system for a better handling of incoming and outgoing calls.

### SUMMARY OF THE INVENTION

The system and method of the invention manage communication between client and server software in an environment comprising at least one mobile station having said client software installed therein, and a contact center for incoming and outgoing calls. The client software and the server software have functionalities for handling information in connection with incoming and outgoing calls. These functionalities include the possibility for the components in the environment to record and connect data to incoming and outgoing calls in order to form a basis according to which calls are handled. The method of the invention includes the performing of these steps.

Different embodiments of the invention are presented in the subclaims.

In this text the term mobile stations is intended to cover all kinds of devices capable to communicate over radio links, such as mobile phones, laptops, PDAs, blackberries, internet tablets etc.

The recording of data can be performed by the mobile station and sent to the contact center or vice versa and it can be formatted in order to facilitate the handling of the calls. The information can also be attached to a call to be further transferred by the contact center or the mobile station can attach information to an outgoing call to be received by the contact center before the call is placed. Furthermore, said stored information includes application information added or updated with further resources and definitions, such as images, display formats, audio, video and textual contents.

The mobile station can accept, decline or transfer an incoming call on the basis of call related data connected to the incoming call by the contact center before or after the call has been transferred to the mobile station.

The mobile station can also store and manage availability information so that this information would be available for the contact center, which can then direct the calls on the basis of said availability information.

In one embodiment, the mobile station can accept, decline, transfer calls on the basis of statistic and queue data published by the contact center with respect to incoming calls.

It is in some embodiments also possible for the mobile station to monitor contact center data remotely in connection with incoming and outgoing calls on the basis of statistic and queue data including e.g. the availability of agents taking incoming calls, call duration statistics, average number of incoming calls per time unit, waiting time for customers in queue, and customer queue lengths.

Data with respect to incoming calls can be displayed on the screen of the mobile station.

Broadcast call requests can be sent to several mobile stations and subsequent routing of the call to a mobile station that accepted the call.

Further possible functionalities include the possibility for the mobile station to use contact center data for managing outgoing calls with respect to given projects as a result of a push from the contact center or a request thereto.

In an environment comprising more than one contact center for an individual mobile station, the functionalities might further include the possibility to centralized management of state information for the individual mobile station with respect to calls routed to and accepted by said mobile station.

In current systems, mobile stations are not integrated with contact center software. The present invention, in turn, allows a mobile worker to be connected with the contact center for performing e.g. routing and call handling, which is based on data connected to incoming and outgoing calls.

The invention provides a very practical solution. In every day life, a worker can by means of an certain invention implementation e.g. just activate a piece of software (the client application) in his mobile phone and select a value on the phone for telling is availability information. Different values to select can e.g. be “Not available”, “In a meeting”, “taking calls” etc.

When then, e.g. a customer with a complex request calls the contact center and wishes to speak with a certain employee, the contact center first connects call related data to the call and then checks the availability information of the relevant employee. If the relevant employee has selected the value “taking calls”, the contact center sends a time-limited call, waits for the answer and then turns the call for another worker being able to handle the customer case in question. The worker receives a note in e.g. the form “Customer X is calling about project Y” and the worker has some time (the defined time-limit) to accept or reject the call, which he can do on the basis of data connected to the call. If the worker accepts the call, the contact center routes the call through an appropriate channel such as VoIP (Voice Over Internet Protocol), GSM (Global System for Mobile communications) or Private Branch Exchange (PBX). It allows a number of attached telephones to make calls to one another, and to connect to other telephone services including the PSTN (The Public Switched Telephone Network, the network of the world's public circuit-switched telephone networks).

The worker and the customer then converse, and the worker has the possibility to fill in free form notes or a structured (formatted) company specific form and store them. After the call, the form or the notes can be automatically submitted to the contact center software with appropriate identification, and the contact center will store these things for further processing.

In a typical flow event, the contact center software sends a call request to the server software. The server software wraps the call request in a message queue message wrapper and puts the message in a queue. The client application receives the call request and displays the request on the client screen in accordance with current configuration parameters. The user selects an appropriate response, e.g presses “accept” or “reject” which could be mapped to a softkey. The call request answer message is put in the queue and sent back to the mobility server. The mobility server unwraps the message and invokes a contact center software web service API (An Application Programming Interface (API) is the interface that a computer system, library or application provides in order to allow requests for services to be made of it by other computer programs, and/or to allow data to be exchanged between them.) to send the response back to the contact center software. The contact center software will then make a decision on what to do next, based on the response to the call request. Typically, a call setup and connection of a physical call to the mobile station would take place after processing of the accepted call request.

It is the combination of data transport, user interface, client configuration and web services API to create a configurable contact center extension in the mobile device that makes the invention so unique.

The invention makes it possible for an enterprise to engage a wider and mobile community in customer care in a controlled manner. The mobile worker will receive background information to an incoming call request making it possible for him or her to make an informed decision about taking or not taking the proposed incoming customer call. The worker's notes about the call and basic information about the call, such as the duration of the call, can be delivered to the contact center software after the call.

In the following, the invention will be further described in connection with some example embodiments by means of figures to the details of which the invention is not restricted.

### FIGURES

FIG. 1 is an architecture overview of the system of the invention

FIG. 2 is a signal diagram of an embodiment of the method of the invention, wherein a mobile station accepts a call on the basis of call related data.

FIG. 3 is a signal diagram of an embodiment of the method of the invention, wherein outgoing calls with respect to a given project are managed.

FIG. 4 is a signal diagram of an embodiment of the method of the invention, wherein outgoing calls are handled by means of call background information

### DETAILED DESCRIPTION

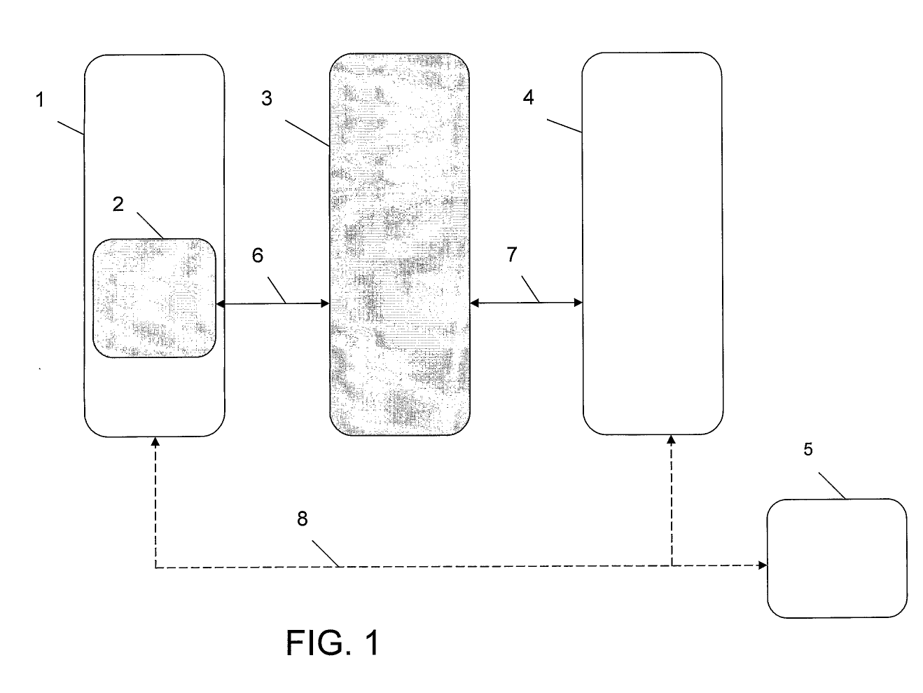

FIG. 1 is an architecture overview of the system of the invention. The system manages communication between client software 2 and server software 3 in an environment comprising at least one mobile station 1 having said client software 2 installed therein, and a contact center 4 for incoming calls. The server software can be installed e.g. in a separate server or e.g. in the contact center. The software components 2, 3 in the system are coloured grey to distinguish them from the physical components 1, 4 and 5.

The calls in the system might consist of incoming calls from a consumer telephone 5 either to the mobile device 1 directly or to the contact center 4. The calls from the consumers might use different mobile channels 8 such as a 2G mobile channel, a 3G mobile channel or a VoIP channel. Also the other components communicate with each other through e.g. IP channels 6, 7.

The client software 2 and the server software 3 have functionalities for handling information in connection with incoming and outgoing calls. In accordance with claim 1, these functionalities include the possibility for the components in the environment to record and connect data to incoming and outgoing calls in order to form a basis according to which calls are handled.

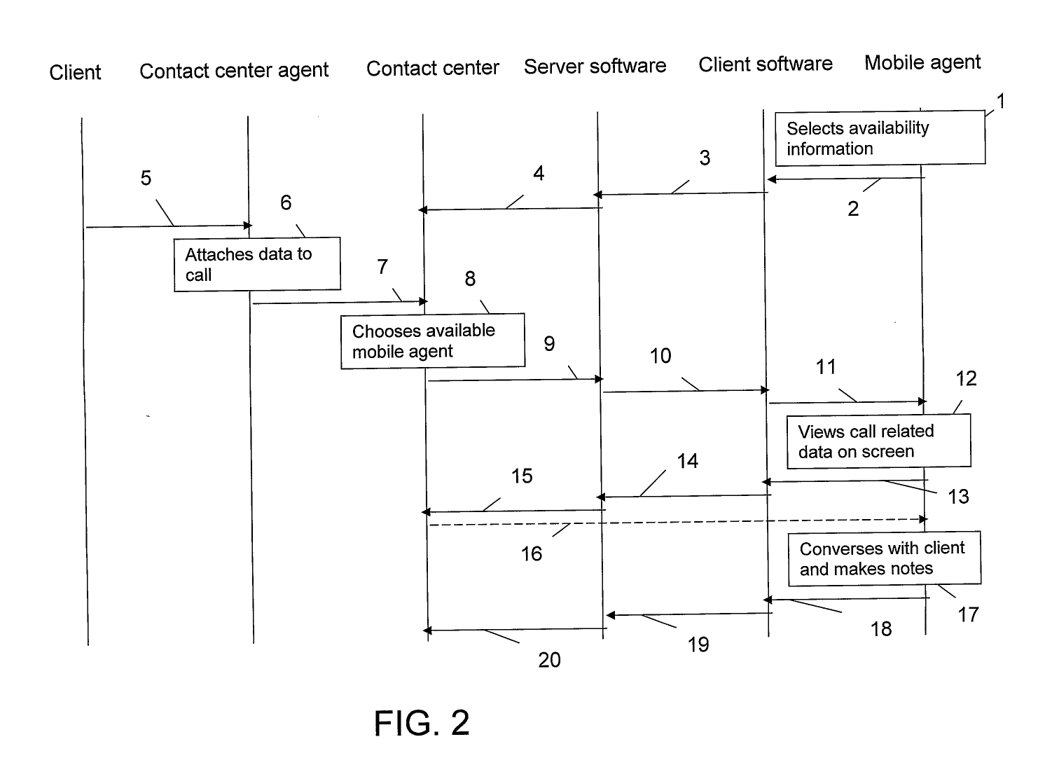

In accordance with claims 2, 5-7, 9-10 and 14, said functionalities include the possibility for the mobile station to store availability information as managed by the mobile station in a way to be available for the contact center. The contact center directs the calls on the basis of said availability information. Said functionalities further include the possibility for the contact center to attach information to a call to be further transferred to the mobile station in case of an incoming call from e.g. a customer. The mobile station can accept, decline or transfer an incoming call on the basis of call related data connected to the incoming call by the contact center. The data with respect to the incoming call can be displayed on the screen of the mobile station and it can be made by means of images, desired display formats, audio, video and textual contents. The functionalities further include the possibility for the mobile station to store formatted information created during a call and optionally send it to the contact center. FIG. 2 shows a signal diagram of an embodiment of the method of the invention to illustrate said functionalities.

A mobile agent first selects a value in step 1 of FIG. 2 according to which he is on-line but only conditionally available, meaning that he wants to answer call on the basis of call related data. This availability information is then forwarded with signal 2 via the client software in the mobile station further with signal 3 to the server software and finally with signal 4 to the contact center.

It is now assumed that a customer makes an incoming call to an enterprise in accordance with signal 5 of FIG. 2, wherein a caller calls and the call is answered by a contact center agent. The contact center agent attaches call related data to the call in step 6 and forwards it to the contact center in signal 7. The contact center chooses such a mobile agent to forward the call to in step 8 who is available and can handle the issue by the caller. The contact center then forwards the call request (not yet the call itself) further to the server side software in signal 9, which in turn forwards it to the client software in signal 10. The client software displays the data with respect to the incoming calls on the screen of the mobile station in signal 11 and the mobile agent can view the call related data in step 12 on the screen in a predetermined format by reading text, viewing images or video or by listening to audio or video. The mobile agent this decides to accept the call, which information is forwarded with signal 13 via the client software and server software (signal 14) to the contact center (signal 15). Now the contact center forwards the real call to the mobile agent in signal 16 over the telephony network. In step 17 the caller and the mobile agent converse and the mobile agent makes notes during the call, which he stores and after the call sends them to the contact center via signals 18-20.

If in step 12, the mobile agent had considered the call not important enough for the time or if had been too busy to accept the call, he could have in signals 13-15 informed the contact center to reject the call and the contact center would then repeat step 8 and choose another mobile agent and send signals 9-11 to that agent instead. It is also possible that the first mobile agent himself would transfer the call request to another mobile agent to follow the functionality presented in claim 7.

The call related data attached by the contact center in step 6 might consist of information about who the caller is and information about the subject the caller want to discuss. It can also consist of statistic and queue data that is published by the contact center. In such a case, the mobile agent can take into consideration facts about how busy the situation is at the contact center and even transfer the call on the basis of that (to follow the functionality presented in claim 11) or monitor the contact center behavior remotely (to follow the functionality presented in claim 12).

Still one possibility is that if the mobile agent does not answer the call request sent with signals 9-11 at all, then after a predetermined time-limit, the client application installed in the mobile agent's mobile station automatically rejects the call request and the contact center would then repeat step 8 and choose another agent to follow the functionality presented in claim 8.

It is also possible for the server software to send the reject on behalf of the client if the client does not respond in a timely manner.

A further possibility is that, instead of sending only a call request in steps 9-11, the contact center forwards the call directly with said call related data attached and the mobile agent can handle the call in similar to the call request presented above to follow the functionality alternative presented in claim 7 to be performed after the call.

A further possibility is that, instead of using availability data, as is done in FIG. 2, a broadcast call request can be sent to several mobile stations, and the call can then be routed to a mobile station that accepted the call.

If the system comprises more than one contact center for an individual mobile station, the functionalities can include a possibility to centralized management of state information for the individual mobile station with respect to calls routed to and accepted by said mobile station so that other contact centers would know when a certain mobile station is busy.

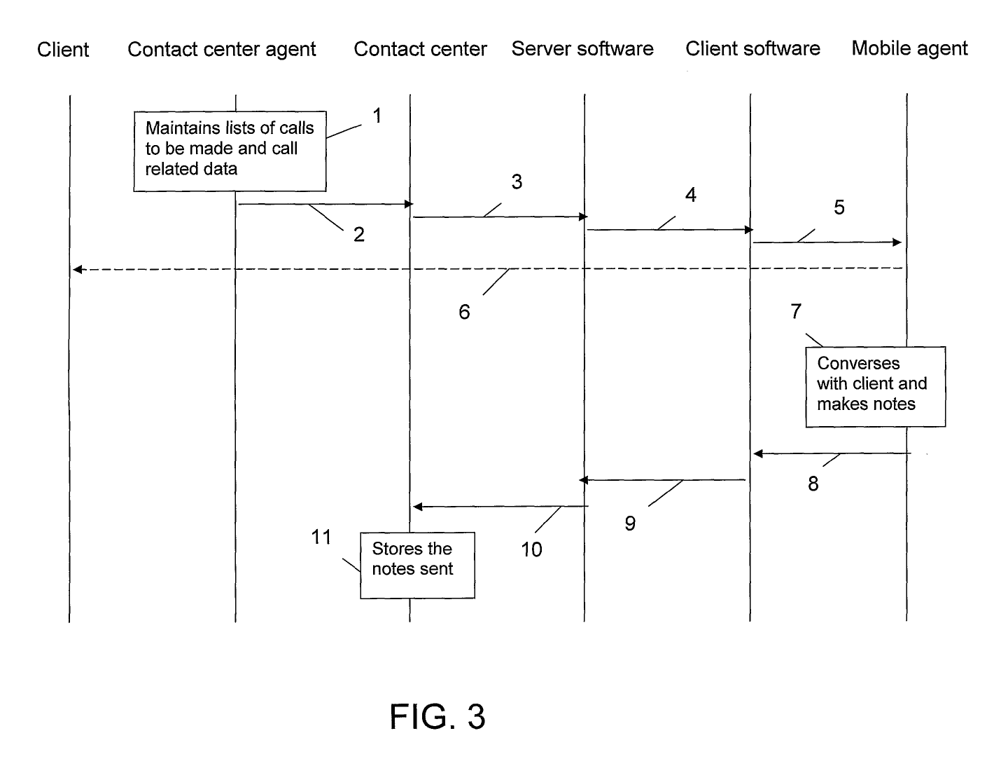

The invention can also be used to manage e.g. sales campaigns as is presented in claim 16 and illustrated in FIG. 3.

It is in FIG. 3 assumed that the contact center maintains and manages information about a sales campaign, which is presented as step 1. The contact center might e.g. have a list of clients that the mobile agents working in the campaign should call to. The sales campaign information also includes information about which clients are already called to, which customers should be called for the first time and which clients should be called again. The information also includes notes sent by the mobile agents about the outcome of the calls made to the clients. In signals 2-5, the contact center sends a request to a mobile agent via the contact center, server software and client software, to call one or more clients and attaches call and client related data to the request so that the mobile agent should know what the actual situation is. In this example, the mobile agent then calls to an agent requested in signal 6. Possibly, the mobile agent might send a signal to the contact center that he accepted the request to call to that agent (not shown). In step 7, the mobile agent converses with the client and makes notes. After the call, the mobile agent sends the notes to the contact center in signals 8-10 so that the contact center could store the outcome of the call, which is performed in step 11.

A slightly different version from FIG. 3 is that the mobile agent itself asks for a client from the contact center to whom he could call and the contact center replies with a message corresponding to signals 2-5 in FIG. 3.

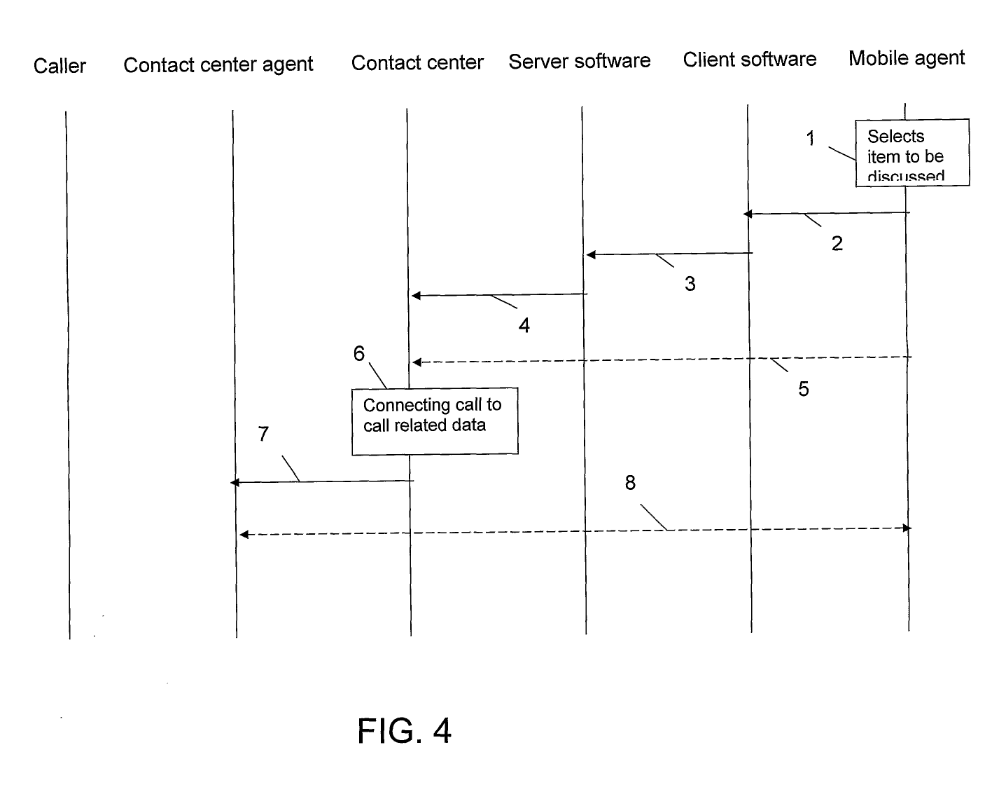

In FIG. 4 outgoing calls are handled by means of call background information. It is assumed that a mobile agent wishes to discuss an item with the contact center. In step 1, he therefore selects the item to be discussed. It might e.g. be question about a user using an online banking client application in the mobile station, with which he can view the latest transactions. The item selected in step 1 can then be a query about one of the transactions. For this discussion, the user sends item related data to the contact center with signals 2-4 via the client software and server software. An outgoing call is then performed over the telephony network (another channel than with which signals 2-4 were sent), called signal 5 in FIG. 4. In step 6, the contact center connect the information to the call and in signal 7, the contact center transfers the call with the call related data to a contact center agent, and then the contact center agent and the mobile user can discuss the item (step 7)

1. A system for managing communication between client and server software in an environment, comprising:
a mobile station having the client software installed therein, and a contact center for incoming and outgoing calls,
the client software and the server software having functionalities for handling information in connection with the incoming and outgoing calls, the functionalities having means for enabling components in the environment to record and connect data related to the incoming and outgoing calls in a call request before a call is placed in order to form a basis according to which the incoming and outgoing calls are handled before or after the call is placed.

2. The system of claim 1 wherein the functionalities have means for enabling the mobile station to store formatted information created during the call and send the call to the contact center.

3. The system of claim 1 wherein the functionalities have means for enabling the contact center to store formatted information created during the call and send the call to the mobile station.

4. The system of claim 1 wherein the functionalities have means for enabling the mobile station to attach information to the call to be further transferred by the contact center.

5. The system of claim 1 wherein the functionalities have means for enabling the mobile station to attach information to an outgoing call to be received by the contact center before the outgoing call is placed.

6. The system of claim 2 wherein the stored information has application information added or updated with resources and definitions.

7. The system of claim 1 wherein the functionalities have means for enabling the mobile station to accept, reject or transfer an incoming call on a basis of call-related data connected to the incoming call by the contact center before or after the incoming call has been transferred to the mobile station.

8. The system of claim 1 wherein the functionalities have means for enabling the mobile station to automatically reject an incoming call when the incoming call is not answered within a given time limit.

9. The system of claim 1 wherein the functionalities have means for enabling the mobile station to store available information as managed by the mobile station to be available for the contact center.

10. The system of claim 9 wherein the functionalities have means for enabling the contact center to direct the incoming and outgoing calls on a basis of the available information.

11. The system of claim 1 wherein the functionalities have means for enabling the mobile station to accept, decline, transfer calls on a basis of statistic and queue data published by contact center with respect to the incoming calls.

12. The system of claim 1 wherein the functionalities have means for enabling the mobile station to monitor contact center data remotely in connection with the incoming and outgoing calls on a basis of statistic and queue data.

13. The system of claim 11 wherein the statistic data have information on an availability of agents taking incoming calls, call duration statistics, average number of incoming calls per time unit, waiting time for customers in queue, and customer queue lengths.

14. The system of claim 1 wherein the functionalities have means for displaying data with respect to the incoming calls on a screen of the mobile station.

15. The system of claim 1 wherein the functionalities have means for sending broadcast call requests to several mobile stations and subsequent routing of broadcast call to a mobile station that accepted the broadcast call.

16. The system of claim 1 wherein the functionalities have means for enabling the mobile station to use contact center data for managing the outgoing calls with respect to given projects as a result of a push from the contact center or a request to the contact center.

17. The system of claim 1 wherein the environment comprises more than one contact center for an individual mobile station and the functionalities have means for centralizing management of state information for the individual mobile station with respect to calls routed to and accepted by the mobile station.

18. A method for managing communication between client and server software in an environment, comprising:
providing at least one mobile station having the client software installed therein, and a contact center for incoming calls,
the client software and the server software having functionalities for handling information in connection with the incoming and outgoing calls,
recording and connecting data related to the incoming and outgoing calls,
sending the data in a call request before a call is placed, and
handling the calls on a basis of the data.

19. The method of claim 18 wherein the method further comprises the mobile station creating information during a call, storing the information in a predetermined format and sending the information to the contact center.

20. The method of claim 18 wherein the method further comprises the contact center sending information connected to a call to the mobile station during the call.

21. The method of claim 18 wherein the method further comprises the mobile station attaching information to a call and sending the call to the contact center before an actual call to the contact center.

22. The method of claim 18 wherein the method further comprises the contact center attaching information to a call.

23. The method of claim 18 wherein the method further comprises the mobile station accepting, rejecting and transferring an incoming call on a basis of call-related data connected to the incoming call by the contact center before or after the incoming call has been transferred to the mobile station.

24. The method of claim 18 wherein the method further comprises the mobile station automatically rejecting an incoming call request when the incoming call is not answered within a given time limit.

25. The method of claim 18 wherein the method further comprises the mobile station storing available information to be available for the contact center.

26. The method of claim 25 wherein the method further comprises the contact center directing the incoming and outgoing calls on a basis of the available information.

27. The method of claim 18 wherein the method further comprises the mobile station accepting, declining and transferring calls on a basis of statistic and queue data published by the contact center with respect to the incoming calls.

28. The method of claim 18 wherein the method further comprises the mobile station monitoring the contact center data remotely in connection with the incoming and outgoing calls on a basis of statistic and queue data.

29. The method of claim 18 wherein the method further comprises a broadcast call request is being sent to several mobile stations and the broadcast call is routed to a mobile station that accepts the broadcast call.
